(19) United States
(12) Patent Application Publication
(10) Pub. No.: US 2025/0052557 A1
(43) Pub. Date: Feb. 13, 2025

(54) Device for Identifying and Locating a Collision, Method for Operating Same and Motor Vehicle Containing same

(71) Applicant: Robert Bosch GmbH, Stuttgart (DE)

(72) Inventor: Suvin Vasu, Bietigheim-Bissingen (DE)

(21) Appl. No.: 18/720,284

(22) PCT Filed: Nov. 15, 2022
(86) PCT No.: PCT/EP2022/081931

§ 371 Date: Jun. 14, 2024

(30) Foreign Application Priority Data
Dec. 16, 2021 (DE) 10 2021 214 553.1

(51) Int. Cl. G01B 7/16

(52) U.S. Cl. CPC G01B 7/18

(57) ABSTRACT

An apparatus for identifying and localizing a collision between a motor vehicle and an external object is disclosed. The apparatus includes an acquisition unit. The acquisition unit is designed to detect a change in an electrical resistance of at least one region of the acquisition unit which results from the collision.

The present invention relates to an apparatus for identifying and localizing a collision of a motor vehicle with an external object, a method for operating the same, and a motor vehicle comprising said apparatus according to the preamble of the independent claims.

### PRIOR ART

A feedback system for monitoring a collision of a motor vehicle is known from document CN105128796A, wherein the feedback system comprises at least one force sensor.

A motor vehicle is known from document DE102012008974 A1, in which the motor vehicle comprises at least one sensor means for acquiring a collision of the motor vehicle with a third object. The at least one sensor means is configured here in the form of a grid which extends over a surface area and consists of at least one current-carrying line and to which an acquisition device is assigned, which identifies a collision based on a change in the flow of current which results from a line deformation caused by a collision.

### DISCLOSURE OF THE INVENTION

According to the present invention, an apparatus for identifying and localizing a collision of a motor vehicle with an external object is provided, which has the characterizing features of the independent claims.

The apparatus according to the invention comprises an acquisition unit that is designed to acquire a change in an electrical resistance of at least one region of the acquisition unit which results from the collision.

The apparatus according to the invention is used to detect a collision and determine the location of its occurrence on a motor vehicle. Based on this collision-relevant information, in the event of a safety-critical collision, for example, an airbag is deployed, for instance to protect the passengers. In the event of a non-critical collision, unnecessary deployment of the airbag, for example, is avoided. Meanwhile, the driver of the motor vehicle is informed about the non-critical collision, for example; for instance so that the driver can find a workshop. In the workshop, however, there is no longer a need for a lengthy inspection to determine where the collision occurred.

Further advantageous embodiments of the present invention are the subject matter of the subclaims.

For example, it is advantageous if the acquisition unit is tubular.

The tubular acquisition unit can be of any length, depending on the requirements, so that a bigger area of a motor vehicle is covered by the tubular acquisition unit. This reduces the number of acquisition units needed to identify and localize a collision.

It is also advantageous if the acquisition unit is electronically coupled to a measuring unit, which comprises a signal generator for generating and transmitting a first signal to the acquisition unit and a signal receiver for receiving a second signal from the acquisition unit.

The measuring unit is electronically connected to one end of the, for example tubular, acquisition unit, for instance, while the other end of the tubular acquisition unit is electrically connected to the measuring unit, for example, such that the acquisition unit is loaded with the internal resistance of the measuring unit as a load.

It is furthermore advantageous if the measuring unit is designed to calculate a ratio between the first and the second signal along the acquisition unit.

By calculating the ratio between the first and the second signal, a collision is identified without the need for expensive visual sensors. If the ratio has a value greater than one, a collision has occurred. The ratio is a standing wave ratio, for instance, which represents the correspondence of the line wave resistance of the, for example tubular, acquisition unit with the load resistance of said acquisition unit.

According to a further aspect of the present invention, a method for identifying and localizing a collision of a motor vehicle with an external object by means of an apparatus according to the invention comprising an acquisition unit and a measuring unit is provided.

In the method according to the invention, a change in an electrical resistance of at least one region of the acquisition unit which results from a collision is acquired by the acquisition unit.

It is advantageous if a first signal is sent from the measuring unit to the acquisition unit and a second signal is sent from the acquisition unit to the measuring unit and if a change in an electrical resistance of at least one region of the acquisition unit is acquired by said acquisition unit.

It is also advantageous if the location of the occurrence of the collision on the motor vehicle is ascertained by the measuring unit taking into account at least the length of the acquisition unit, which is tubular, and the time duration until the second signal is received by the measuring unit.

It is furthermore advantageous if the severity of the collision is ascertained by the measuring unit based on a ratio between the first and the second signal.

According to a third aspect of the present invention, a motor vehicle is provided.

The motor vehicle according to the invention comprises a previously described apparatus for identifying and localizing a collision of a motor vehicle with an external object. It is provided that an acquisition unit of the apparatus is disposed in an inner region of the motor vehicle, in a location on the outer region of which a collision of the motor vehicle with an external object is to be expected.

### BRIEF DESCRIPTION OF THE FIGURES

Advantageous embodiments of the present invention are shown in the drawing and explained in more detail in the following description of the figures. The figures show:

FIG. 1 an example plan view onto a motor vehicle according to an embodiment of the present invention, and

FIG. 2 an example flowchart of a method for identifying and localizing a collision of a motor vehicle with an external object according to an embodiment of the present invention.

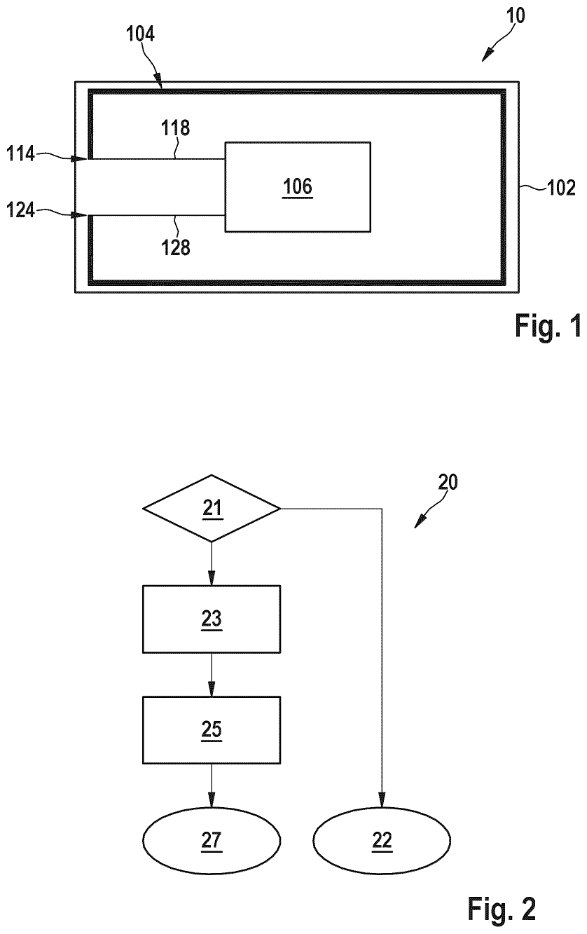

FIG. 1 shows a plan view onto a motor vehicle 10 comprising an acquisition unit 104 and a measuring unit 106 according to an embodiment of the present invention.

The motor vehicle 10 includes a body 102, for instance, within and along the inner region of which the acquisition unit 104 is, for example, mounted. The acquisition unit 104 is configured as a coaxial cable, for instance, which comprises a first and a second end 114, 124. The first end 114 of the acquisition unit 104 is electronically connected to a first connection 118 of the measuring unit 106, for example, while the second end 124 of the acquisition unit 104 is electrically connected to a second connection 128, for example. The measuring unit 106 comprises a signal transmitter and a signal receiver, for instance.

The signal transmitter of the measuring unit 106 serves to transmit a first signal to the acquisition unit 104, for example, wherein the first signal in the form of a first voltage pulse U₁ is present and passes through the acquisition unit 104 from its first end 114 to its second end 124. The signal receiver of the measuring unit 106, on the other hand, serves to acquire a second signal of the acquisition unit 104, for example, wherein the second signal in the form of a second voltage pulse U₂ is present and passes through the acquisition unit 104 from its second end 124 to its first end 114.

The second signal in the form of the second voltage pulse U₂ is present only if a change in an electrical resistance of a section of the acquisition unit 104 has been caused by a collision.

If the second signal in the form of the second voltage pulse U₂ is present, a standing wave ratio SWV between the first signal in the form of the first voltage pulse U₁ and the second signal in the form of the second voltage pulse U₂ is calculated, for example according to the following equation:

$$SWV = \frac{\vert {U}_{1} \vert + \vert {U}_{2} \vert}{\vert {U}_{1} \vert - \vert {U}_{2} \vert} \qquad ( 1 )$$

The respective absolute value |U₁|, |U₂| of the first and the second voltage pulse U₁, U₂ are taken into account. If the standing wave ratio SWV has a value greater than one, a collision of the motor vehicle 10 with an external object, such as a stationary other motor vehicle, has occurred. The larger the standing wave ratio SWV, the more severe the collision of the motor vehicle 10, for example.

The localization of the collision on the motor vehicle 10 is ascertained by means of a digital signal processor of the measuring unit 106, for example. The period of time starting with the transmission of the first signal in the form of the first voltage pulse U₁ to the reception of the second signal in the form of the second voltage pulse U₂, for example, is taken into account. The length of the acquisition unit 104 and the respective wavelength of the first and the second voltage pulses U₁, U₂, for instance, are taken into account as well. Thus, it is ascertained from where within the acquisition unit 104 the second signal in the form of the second voltage pulse U₂ is sent to the measuring unit 106. This location of the occurrence of the second signal in the form of the second voltage pulse U₂ in the acquisition unit 104 corresponds to an outer region on the motor vehicle 10, at which the collision occurred.

FIG. 2 shows an example flowchart of a method 20 for identifying and localizing a collision of a motor vehicle, for example a motor vehicle 10 according to FIG. 1, with an external object according to an embodiment of the present invention. The same reference signs indicate the same components as in FIG. 1.

In a first method step 21, it is ascertained whether a second signal in the form of a second voltage pulse U₂ is present. If no second signal in the form of the second voltage pulse U₂ is received by the signal receiver of the measuring unit 106, it is determined in a first final method step 22 that no collision of the motor vehicle 10 has occurred.

If the second signal in the form of the second voltage pulse U₂ is present, the standing wave ratio SWV is calculated in a second method step 23 according to equation (1). If the standing wave ratio SWV has a value greater than one, a collision is identified in a third method step 25 and the location of the occurrence of the collision is ascertained, taking into account at least the length of the acquisition unit 104 and the time duration until the second signal in the form of the second voltage pulse U₂ is received by the signal receiver of the measuring unit 106. In the third method step 25, the amplitude of the second signal in the form of the second voltage pulse U₂, for instance, is also acquired, for example by the signal receiver of the measuring unit 106. The greater the amplitude of the second voltage pulse U₂, the more severe the collision of the motor vehicle 10. In a second final method step 27, depending on the severity of the collision, the information about the collision is displayed to the driver of the motor vehicle 10, for example, on a screen installed in the motor vehicle 10.

The invention claimed is:

1. An apparatus for identifying and localizing a collision of a motor vehicle with an external object, comprising:
an acquisition unit,
wherein the acquisition unit is designed to detect a change in an electrical resistance of at least one region of the acquisition unit which results from the collision.

2. The apparatus according to claim 1, wherein the acquisition unit is tubular.

3. The apparatus according to claim 1, wherein:
the acquisition unit is electronically coupled to a measuring unit, and
the measuring unit comprises (i) a signal generator configured to generate and transmit a first signal to the acquisition unit, and (ii) a signal receiver configured to receive a second signal from the acquisition unit.

4. The apparatus according to claim 3, wherein the measuring unit is designed to calculate a ratio between the first signal and the second signal.

5. A method for identifying and localizing a collision of a motor vehicle with an external object by way of an apparatus comprising an acquisition unit and a measuring unit according to claim 1, the method comprising:
using the acquisition unit to acquire a change in an electrical resistance of at least one region of the acquisition unit which results from the collision.

6. The method according to claim 5, wherein a first signal is sent from the measuring unit to the acquisition unit and a second signal is sent from the acquisition unit to the measuring unit when a change in an electrical resistance of at least one region of the acquisition unit is acquired by said acquisition unit.

7. The method according to claim 6, wherein the location of the occurrence of the collision on the motor vehicle is ascertained by the measuring unit taking into account at least the length of the acquisition unit, which is tubular, and the time duration until the second signal is received by the measuring unit.

8. The method according claim 6, wherein the severity of the collision is ascertained by the measuring unit based on a ratio between the first signal and the second signal.

9. A motor vehicle comprising an apparatus according to claim 1, wherein an acquisition unit of the apparatus is disposed in an inner region of the motor vehicle, in a location on the outer region of which a collision of the motor vehicle with an external object is to be expected.
